(19) United States
(12) Patent Application Publication
(10) Pub. No.: US 2013/0082451 A1
(43) Pub. Date: Apr. 4, 2013

(54) MULTIFUNCTIONAL VEHICLE

(71) Applicant: Henkel Lin, TAICHUNG (TW)

(72) Inventor: Henkel Lin, TAICHUNG (TW)

(21) Appl. No.: 13/251,326

(22) Filed: Oct. 3, 2011

(51) Int. Cl. B62M 1/00

(52) U.S. Cl. 280/87.021

(57) ABSTRACT

A multifunctional vehicle includes a frame, front and rear rolling gears, a head set, a handlebar, a board, a brake and a tube. The frame includes two first, second and third crossbars for interconnecting two lateral bars. The front rolling gear is rotationally connected to the lateral bars by the head set. The handlebar is connected to the front rolling gear. The rear rolling gear is connected to the third crossbar. The board includes a hook for engagement with the first crossbar as the board is in an upper position and for engagement with the second crossbar as the board is in a lower position. The brake is connected to the board for frictional contact with the rear rolling gear. The tube includes an end pivotally connected to the lateral bars by the second crossbar and another end pivotally connected to the board.

### BACKGROUND OF INVENTION

1. Field of Invention

The present invention relates to a multifunctional vehicle and, more particularly, to a vehicle that can be used as a tricycle or a scooter.

2. Related Prior Art

Referring to FIG. 1, there is shown a conventional tricycle for children. A child rides such a tricycle for fun and exercise before she or he learns to ride a bicycle. It requires only a little sense of balance for the child to ride such a tricycle since it includes three wheels.

Referring to FIG. 2, there is shown a conventional scooter. A child rides such a scooter for fun and exercise before she or he learns to ride a bicycle. It requires more sense of balance for the child to ride such a scooter since it includes only two wheels.

Generally, a child rides a tricycle when she or he is very young and rides such a scooter when she or he grows up a little. It is however difficult and uneconomic to keep a tricycle and a scooter in an apartment that is often small since the costs of dwelling are high in urban areas.

The present invention is therefore intended to obviate or at least alleviate the problems encountered in prior art.

### SUMMARY OF INVENTION

It is the primary objective of the present invention to provide a multifunctional vehicle.

To achieve the foregoing objectives, the multifunctional vehicle includes a frame, front and rear rolling gears, a head set, a handlebar, a board, a brake and a tube. The frame includes two first, second and third crossbars for interconnecting two lateral bars. The front rolling gear is rotationally connected to the lateral bars by the head set. The handlebar is connected to the front rolling gear. The rear rolling gear is connected to the third crossbar. The board includes a hook for engagement with the first crossbar as the board is in an upper position and for engagement with the second crossbar as the board is in a lower position. The brake is connected to the board for frictional contact with the rear rolling gear. The tube includes an end pivotally connected to the lateral bars by the second crossbar and another end pivotally connected to the board.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of a conventional tricycle;

FIG. 2 is a perspective view of a conventional scooter;

FIG. 3 is an exploded view of a multifunctional vehicle according to the preferred embodiment of the present invention;

FIG. 4 is a perspective view of the multifunctional vehicle of FIG. 3 used as a tricycle;

FIG. 5 is a cross-sectional view of the multifunctional vehicle of FIG. 4;

FIG. 6 is a perspective view of the multifunctional vehicle of FIG. 3 used as a scooter;

FIG. 7 is an enlarged, partial, side view of the multifunctional vehicle shown in FIG. 6;

FIG. 8 is a cross-sectional view of the multifunctional vehicle of FIG. 7;

FIG. 9 is another cross-sectional view of the multifunctional vehicle shown in FIG. 7;

FIG. 10 is a perspective view of a brake used in the multifunctional vehicle shown in FIG. 3; and

FIG. 11 is a perspective view of a board used in the multifunctional vehicle shown in FIG. 3.

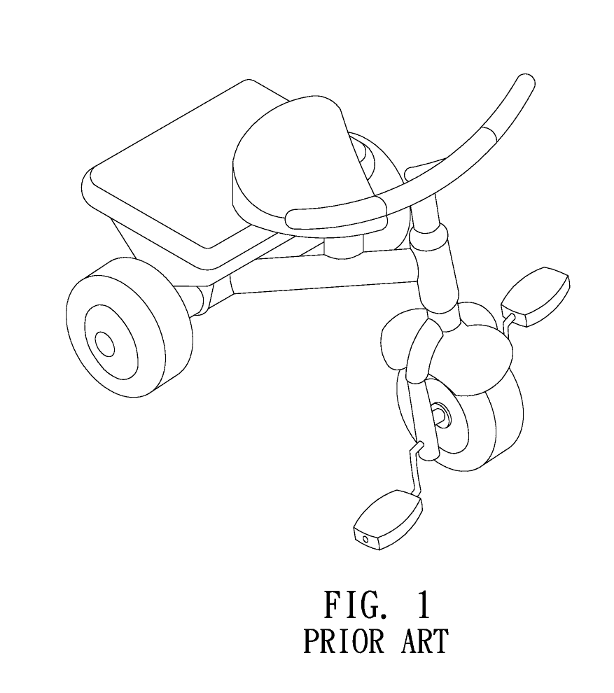

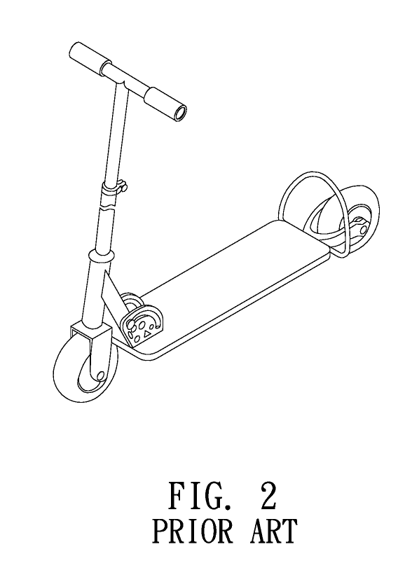

### DETAILED DESCRIPTION OF PREFERRED EMBODIMENT

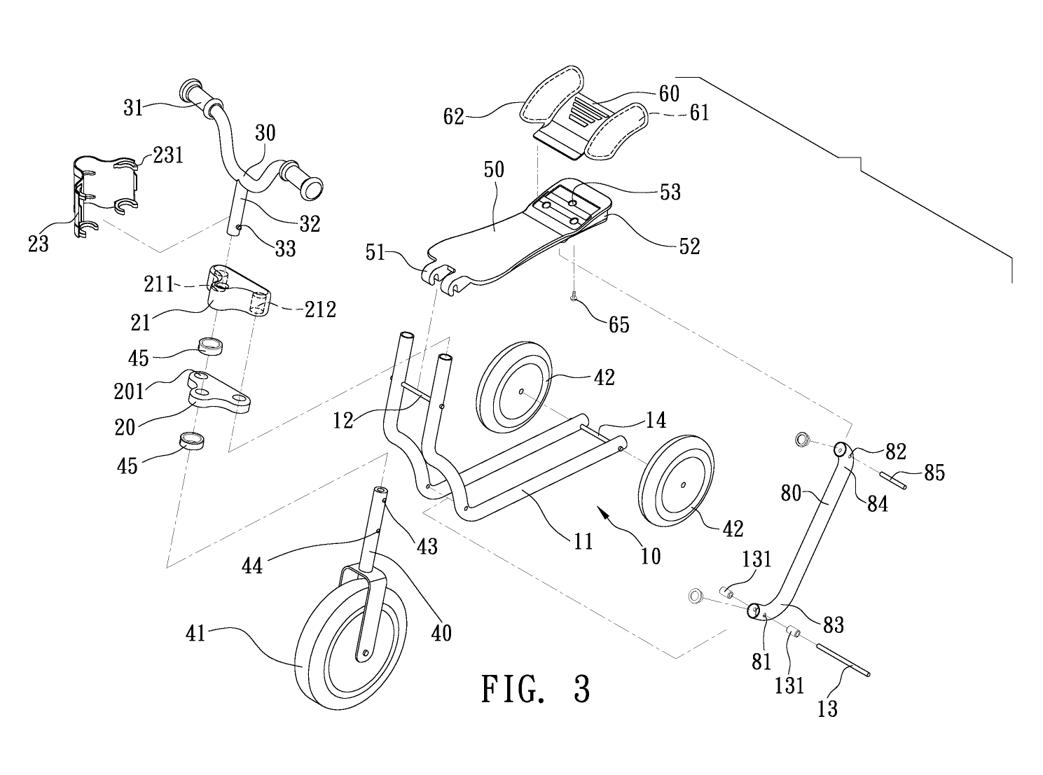

Referring to FIG. 3, there is shown a multifunctional vehicle according to the preferred embodiment of the present invention. The multifunctional vehicle includes a frame 10, a head set, a handlebar 30, a front rolling gear, a rear rolling gear, a board 50, a brake 60 and a tube 80.

The frame 10 includes two lateral bars 11 extending parallel to each other and three crossbars 12, 13 and 14 for interconnecting the lateral bars 11. Each of the lateral bars 11 includes a bent section extending between a vertical section and a horizontal section. The vertical sections of the lateral bars 11 are connected to each other by the first crossbar 12. The bent sections of the lateral bars 11 are connected to each other by the second crossbar 13. The horizontal sections of the lateral bars 11 are connected to each other by the third crossbar 14.

The head set includes two triangular plates 20 and 21 and a cover 23. The first triangular plate 20 includes three apertures 201 defined therein. Each of the apertures 201 is located near a related one of three corners of the first triangular plate 20. The apertures 201 include a front aperture 201 and two rear apertures 201.

Similarly, the second triangular plate 21 includes three apertures 211 defined therein. Each of the apertures 211 is located near a related one of three corners of the second triangular plate 21. The apertures 211 include a front aperture 211 and two rear apertures 211.

The cover 23 is shaped corresponding to the triangular plates 20 and 21. The cover 23 is made with a front face and a rear face. Four clips 231 are formed on the rear face of the cover 23. The clips 231 are shaped compliant to the lateral bars 11.

The handlebar 30 includes a middle section extending between two lateral sections. A grip 31 is provided on and around each of the lateral sections of the handlebar 30. The middle section of the handlebar 30 is transversely connected to an upper end of the stem 32. A spring-biased detent 33 is provided on the stem 32 near a lower end of the stem 32.

The front rolling gear includes a fork 40, a front wheel 41 and two collars 45. The fork 40 includes two prongs and a tubular post. The prongs of the fork 40 extend downward while the tubular post of the fork 40 extends upward. The front wheel 41 is rotationally connected to the prongs of the fork 40. Two apertures 43 and 44 are defined in the tubular post of the fork 40. The apertures 43 and 44 are shaped in compliance with the spring-biased detent 33. The first aperture 43 is located higher than the second aperture 44.

The rear rolling gear includes two rear wheels 42.

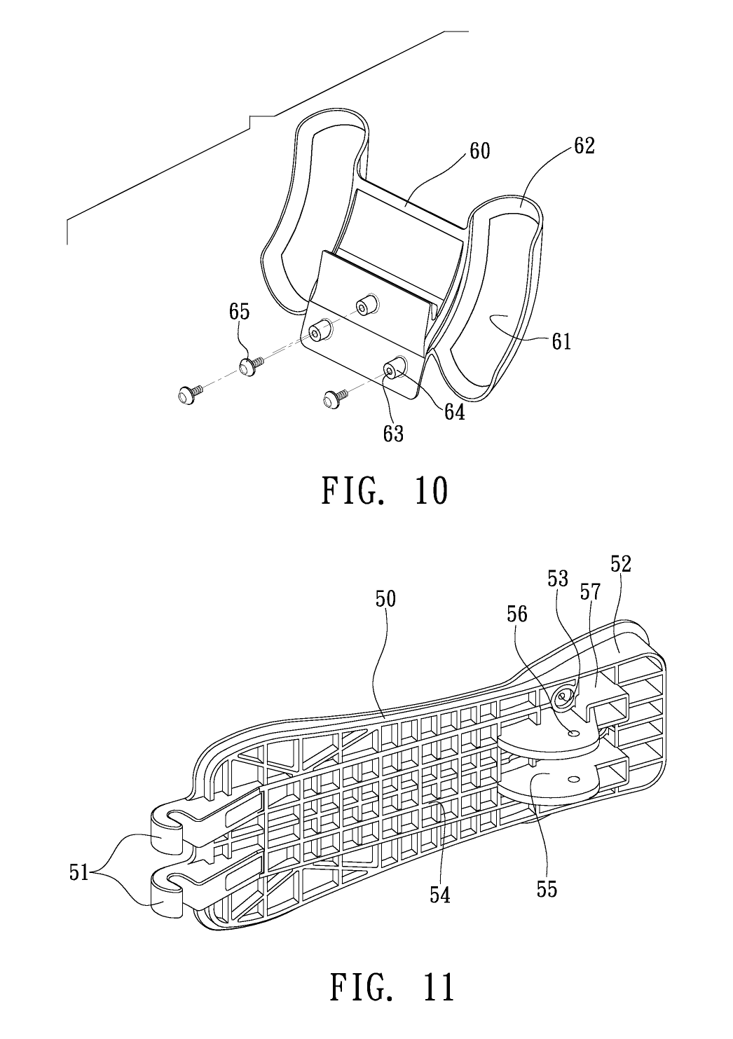

Referring to FIGS. 3 and 11, the board 50 includes two hooks 51, a ramp 52, three apertures 53, ribs 54, two lugs 55 and two reinforcement elements 57. Two hooks 51 are formed at a front end of the board 50. The ramp 52 is formed on an upper face of the board 50 near a rear end of the board 50. The apertures 53 are defined in of the board 50 near the rear end of the board 50. The ribs 54 formed on a lower face of the board 50. The ribs 54 are used to reinforce the board 50. The lugs 55 formed on the lower face of the board 50 near the rear end of the board 50. An aperture 56 is defined in each of the lugs 55. The reinforcement elements 57 formed on the lower face of the board 50. Each of the reinforcement elements 57 is located against a related one of the lugs 55. The reinforcement elements 57 are used to reinforce the lugs 55.

Referring to FIGS. 3 and 10, the brake 60 includes two fenders 62 formed thereon and two linings 61 each attached to a lower face of a related one of the fenders 62. The brake 60 is preferably made of a plastic material so that it is elastic. The fenders 62 are shaped corresponding to the rear wheels 42. The linings 61 are also shaped corresponding to the rear wheels 42. The linings 61 are preferably made of aluminum so that they cannot easily be worn away when they are brought into contact with the rear wheels 42 for braking. Thus, the fenders 62 are protected. Three sleeves 64 are formed on a lower face of the brake 60. A screw hole 63 is defined in each of the sleeves 64. The screw holes 63 are made corresponding to the apertures 53.

The tube 80 includes a first bent section 83 formed at an end thereof and a second bent section 84 formed at another end thereof. A first aperture 81 is defined in the first bent section 83 of the tube 80. A second aperture 82 is defined in the second bent section 84 of the tube 80.

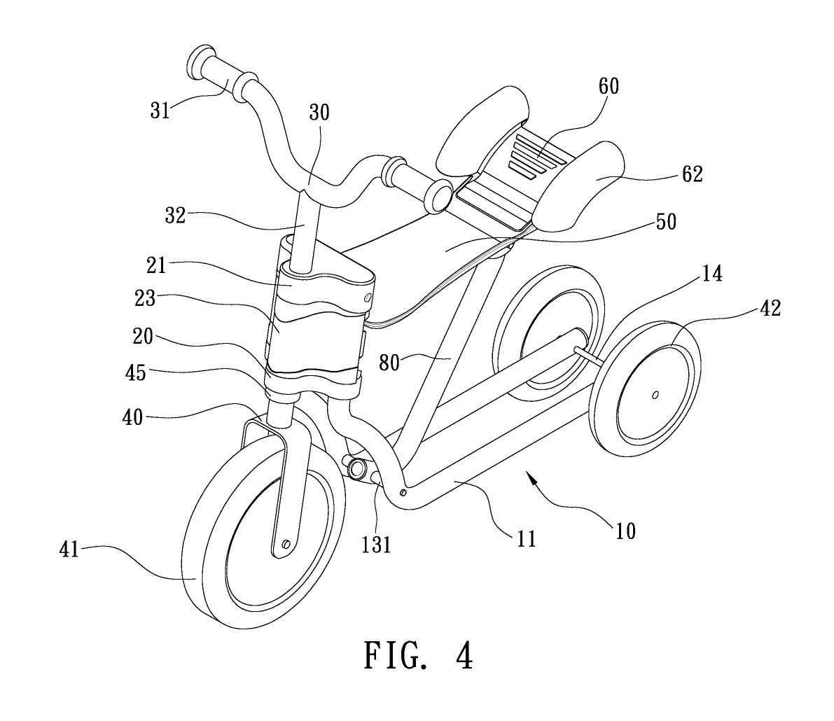

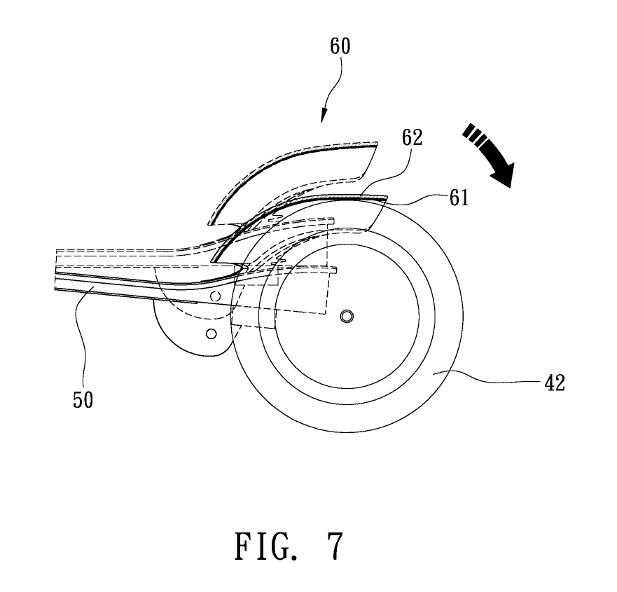

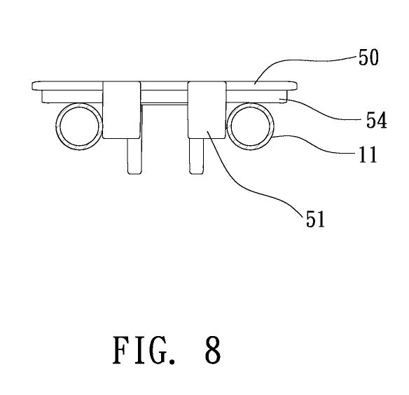

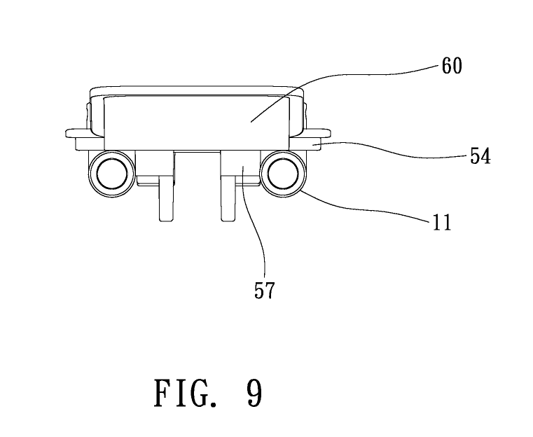

Referring to FIGS. 4 through 9, in assembly, the vertical sections of the lateral bars 11 are inserted in the rear apertures 211 of the second triangular plate 21 through the rear apertures 201 of the first triangular plate 21. The first collar 45 is located beneath the first triangular plate 20 while the second collar 45 is sandwiched between the triangular plates 20 and 21. The clips 231 are engaged with the vertical sections of the lateral bars 11 so that the cover 23 is attached to the lateral bars 11 and that the triangular plates 20 and 21 are covered by the cover 23.

The tubular post of the fork 40 is inserted in the front aperture 211 of the second triangular plate 21 through the front aperture 201 of the first triangular plate 21 and apertures defined in the collars 45. The collars 45 are used for firm connection of the fork 40 to the triangular plates 20 and 21. The apertures 43 and 44 are shielded by the cover 23.

The stem 32 is movably inserted in the tubular post of the fork 40. The stem 32 and the tubular post of the fork 40 thus form a telescopic unit. The spring-biased detent 33 can selectively be inserted in the first aperture 43 or the second aperture 44.

The third crossbar 14 is inserted in the rear wheels 42 through apertures defined in the horizontal sections of the lateral bars 11. Therefore, the rear wheels 42 are rotationally connected to the frame 10.

The second crossbar 13 is inserted in apertures defined in the bent sections of the lateral bars 11, two spacers 131 and the first aperture 81 of the tube 80. Therefore, the tube 80 is pivotally connected to the lateral bars 11 by the second crossbar 13. The spacers 131 are used to position the first bent section of the tube 81 between the bent sections of the lateral bars 11.

A pin 85 is inserted in the apertures 56 of the lugs 55 and the second aperture 82 of the tube 80. Therefore, the tube 80 is pivotally connected to the board 50 by the pin 85.

A screw 65 is driven in each of the screw holes 63 through a related one of the apertures 53. Hence, the brake 60 is connected to the board 50.

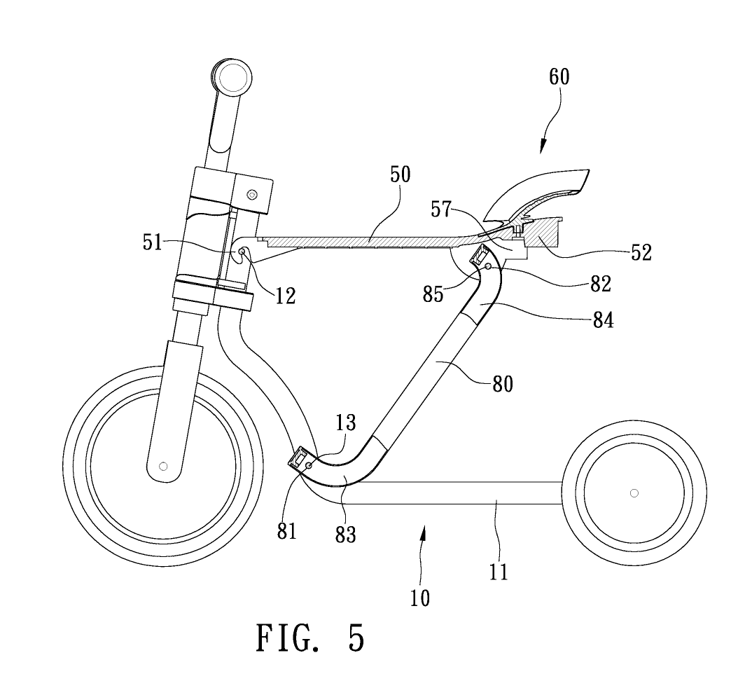

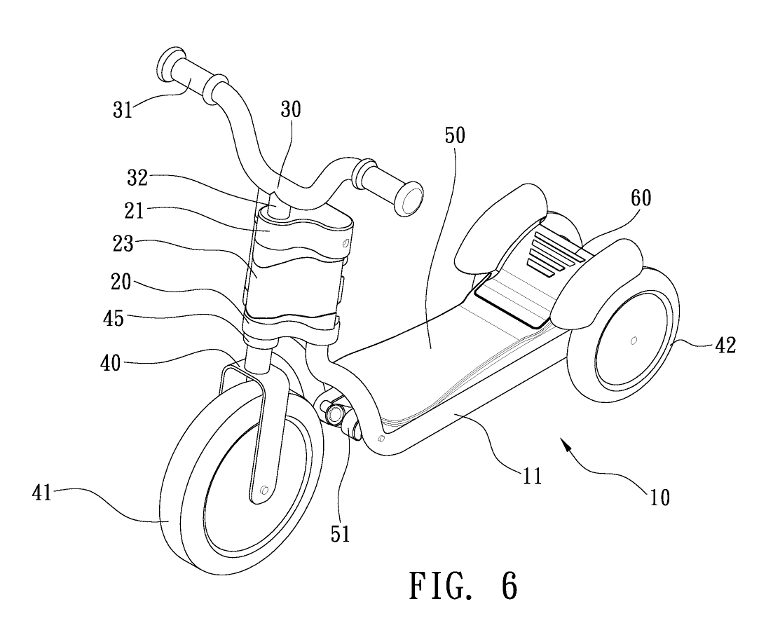

In use, the multifunctional vehicle can be switched between a tricycle mode as shown in FIGS. 4 and 5 and a scooter mode as shown in FIGS. 6 through 9. In the tricycle mode, the hooks 51 are engaged with the first crossbar 12 to retain the board 50 in an upper position and the tube 80 in an inclined position. Now, the board 50 is used as a saddle. Thus, the horizontal sections of the lateral bars 11, the board 50 and the tube 80 together form a triangular structure with adequate rigidity. The spring-biased detent 33 is inserted in the second aperture 44 to retain the handlebar 30 in a lower position. A child can sit on the board 50 and hold the handlebar 30 comfortably and kick the ground with his or her legs to move the multifunctional vehicle while comfortably holding the handlebar 30 with his or her hands.

In the scooter mode, the hooks 51 are engaged with the second crossbar 13 to retain the board 50 in a lower position and the tube 80 in a horizontal position. The board 50 is firmly supported on the lateral bars 11. Now, the board 50 is used as a skateboard. The spring-biased detent 33 is inserted in the first aperture 43 to retain the handlebar 30 in an upper position. A child can stand on the board 50 with a leg and kick the ground with the other leg to move the multifunctional vehicle while comfortably holding the handlebar 30 with the hands.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multifunctional vehicle including:
a frame including two lateral bars and first, second and third crossbars for interconnecting the lateral bars;
a front rolling gear;
a head set for rotationally connecting the front rolling gear to the lateral bars;
a handlebar connected to the front rolling gear;
a rear rolling gear connected to the third crossbar;
a board including at least one hook for engagement with the first crossbar as the board is in an upper position and for engagement with the second crossbar as the board is in a lower position;
a brake elastically connected to the board for frictional contact with the rear rolling gear; and
a tube including a first end pivotally connected to the lateral bars by the second crossbar and a second end pivotally connected to the board.

2. The multifunctional vehicle according to claim 1, wherein the front rolling gear includes:
a fork rotationally connected to the lateral bars by the head set; and
a front wheel rotationally connected to the fork.

3. The multifunctional vehicle according to claim 2, wherein the handlebar includes a stem secured thereto at an end and connected to the fork at another end.

4. The multifunctional vehicle according to claim 2, wherein the head set includes two triangular plates each including a front aperture for receiving the fork and two rear apertures for receiving the lateral bars.

5. The multifunctional vehicle according to claim 4, wherein the head set includes a collar sandwiched between two triangular plates, wherein a portion of the fork is inserted through the collar.

6. The multifunctional vehicle according to claim 5, wherein the head set includes another collar sandwiched between another portion of the fork and one of the triangular plates.

7. The multifunctional vehicle according to claim 4, wherein the head set includes a cover attached to the lateral bars for covering the triangular plates.

8. The multifunctional vehicle according to claim 7, wherein the cover includes at least two clips for engagement with the lateral bars.

9. The multifunctional vehicle according to claim 3, wherein the stem is telescopically inserted in the fork.

10. The multifunctional vehicle according to claim 9, wherein the fork includes upper and lower apertures defined therein, wherein the stem includes an spring-biased detent for insertion in the upper aperture as the board is in the lower position and for insertion in the lower aperture as the board is in the upper position.

11. The multifunctional vehicle according to claim 1, wherein the board includes ribs formed thereon for reinforcement.

12. The multifunctional vehicle according to claim 1, wherein the board includes at least one aperture defined therein, wherein the brake includes at least one screw hole defined therein for receiving a screw inserted through the aperture of the board.

13. The multifunctional vehicle according to claim 1, wherein the rear rolling gear includes at least one rear wheel rotationally connected to the lateral bars by the third crossbar.

14. The multifunctional vehicle according to claim 13, wherein the wherein the brake includes at least one fender located above and near the rear wheel as the board is in the lower position.

15. The multifunctional vehicle according to claim 14, wherein the brake includes at least one lining attached to the fender for frictional contact with the rear wheel.

16. The multifunctional vehicle according to claim 15, wherein the lining is made of aluminum.

17. The multifunctional vehicle according to claim 1, wherein the board includes two lugs formed on a lower face thereof, wherein the second end of the tube is located between and pivotally connected to the lugs.

18. The multifunctional vehicle according to claim 17, including a pin for pivotally connecting the second end of the tube to the lugs.

19. The multifunctional vehicle according to claim 18, wherein each of the lugs includes an aperture for receiving the pin.

20. The multifunctional vehicle according to claim 1, including two spacers each sandwiched between a related one of the lateral bars and the first end of the tube.
